(19) United States
(12) Patent Application Publication
(10) Pub. No.: US 2015/0060539 A1
(43) Pub. Date: Mar. 5, 2015

(54) TELECOMMUNICATIONS SYSTEMS WITH MANAGED CONNECTIVITY

(71) Applicant: ADC Telecommunications, Inc., Berwyn, PA (US)

(72) Inventor: Patrick J. Thompson, Prior Lake, MN (US)

(21) Appl. No.: 14/476,286

(22) Filed: Sep. 3, 2014

Related U.S. Application Data
(60) Provisional application No. 61/873,688, filed on Sep. 4, 2013.

(51) Int. Cl. G02B 6/46; G06K 7/10; G06K 19/07; G02B 6/44; G06K 19/077

(52) U.S. Cl. CPC G02B 6/46; G02B 6/4452; G06K 19/07766; G06K 19/0723; G06K 7/10415
USPC 235/375; 385/135; 235/492; 235/439

(57) ABSTRACT

Management elements (e.g., an RFID tag, an RFID reader, a barcode, a QR code, etc.) can be retro-fitted to cables, connectors, and/or equipment to store PLI for the cables, connectors, and/or equipment after deployment and/or connection of the equipment. The management elements can be added in the field without replacing the telecommunication components or disconnecting cables from the telecommunication components.

### CROSS REFERENCE TO RELATED APPLICATION

This application claims the benefit of U.S. Provisional Application No. 61/873,688, filed Sep. 4, 2013, and titled “Telecommunications Systems with Managed Connectivity,” the disclosure of which is hereby incorporated herein by reference.

### BACKGROUND

Telecommunication systems typically employ a network of telecommunication cables capable of transmitting large volumes of data and voice signals. The signals can be transmitted over relatively long distances in a wide area network or a local network. The signals can also be part of a data communications network, such as in a data center of a building or a campus. The telecommunications cable can include fiber optic cables, electrical cables, or combinations of electrical and fiber optic cables. A typical long distance telecommunications network also includes a plurality of telecommunications enclosures integrated throughout the network of telecommunications cables. The telecommunications enclosures are adapted to house and protect telecommunication components such as splices, splice trays, termination panels, power splitters and wave length division multiplexers. Data centers include telecommunications equipment, storage systems, power supplies, and other equipment.

Physical layer management (PLM) systems have been developed in order to automatically keep track of which cables are attached to which ports throughout the network as well as other types of physical layer information (PLI). Some example PLM systems utilize radio frequency identification (RFID) tags and readers that read, store, and write PLI relating to the various components. Other example PLM systems utilize electrical contacts and memory to read, store, and write PLI relating to the various components.

Improvements are desired.

### SUMMARY

The present disclosure relates to providing PLM for various telecommunication components already deployed within a telecommunication network, such as a fiber optic network or a copper network. Management elements (e.g., an RFID tag, an RFID reader, a barcode, a QR code, etc.) can be added to cables, connectors, and/or equipment to store PLI for the cables, connectors, and/or equipment. The management components can be added to components within a central office, at a fiber distribution hub (FDH), at a multi-service terminal (MST), at an optical network terminal (ONT), and/or at any other location in the network.

Some aspects of the disclosure related to adding management elements to telecommunication components in the field without replacing the telecommunication components. Other aspects of the disclosure related to adding management elements to telecommunication components in the field without disconnecting cables from the telecommunication components. Other aspects of the disclosure related to management elements capable of being installed in the field.

The above noted systems and methods can also be used with any supporting hardware, such as hardware which supports, houses, or checks the equipment, including frames, racks, screens, cameras.

The above noted systems and methods and as further described and claimed can also be used with any type of network (copper or fiber) and whether the network is localized, or used over a wide area. The systems and methods can be used by the system operator for the equipment, the connections, and/or the supporting hardware, as desired.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is an example passive telecommunications network including a central office portion and a field portion, which includes an FDH, an MST, and an ONT, configured in accordance with the principles of the present disclosure;

FIG. 2 is a schematic diagram of an example “field” portion of the passive telecommunications network of FIG. 1;

FIG. 3 is a side elevational view of an example retrofit system mounted to an example adapter and connector at a bulkhead, the retrofit system including an example adapter port tag holder and an example connector tag holder;

FIG. 4 is an end view of the example connector tag holder of FIG. 3;

FIG. 5 is a side elevational view of another example retrofit system including an example adapter port reader holder;

FIG. 6 is a side elevational view of another example retrofit system including another example adapter port reader holder;

FIG. 7 is a perspective view of an example splitter chassis at which management elements can be retrofit;

FIG. 8 is a perspective view of an example cabinet including two termination fields;

FIG. 9 is a schematic diagram of an example retrofit system for providing management elements to a termination field;

FIG. 10 is a schematic diagram of an example holder for providing management elements to a termination field;

FIG. 11 is an example controller configured to operate management elements in example retrofit systems described above.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

Certain aspects of the present disclosure relate to retro-fitting management elements to deployed telecommunications components to provide PLM for the telecommunication components within a telecommunication network, such as a fiber optic network or a copper network. Some example management elements include RFID tags configured to store PLI relating to the respective telecommunications components. Other example management elements include graphic codes (e.g., barcodes, QR codes, etc.) that indicate PLI relating to the respective telecommunications components or a location (e.g., a URL) where such information is stored.

Example PLM networks are disclosed in the following US patent applications (all of which are hereby incorporated herein by reference): U.S. Provisional Patent Application Ser. No. 61/152,624, filed on Feb. 13, 2009, titled “MANAGED CONNECTIVITY SYSTEMS AND METHODS” (also referred to here as the “'624 application”); U.S. patent application Ser. No. 12/705,497, filed on Feb. 12, 2010, titled “AGGREGATION OF PHYSICAL LAYER INFORMATION RELATED TO A NETWORK” (is also referred to here as the '497 application); U.S. patent application Ser. No. 12/705,501, filed on Feb. 12, 2010, titled “INTER-NETWORKING DEVICES FOR USE WITH PHYSICAL LAYER INFORMATION” (also referred to here as the '501 application); U.S. patent application Ser. No. 12/705,506, filed on Feb. 12, 2010, titled “NETWORK MANAGEMENT SYSTEMS FOR USE WITH PHYSICAL LAYER INFORMATION” (also referred to here as the '506 application); U.S. patent application Ser. No. 12/705,514, filed on Feb. 12, 2010, titled “MANAGED CONNECTIVITY DEVICES, SYSTEMS, AND METHODS” (also referred to here as the '514 application); U.S. Provisional Patent Application Ser. No. 61/252,395, filed on Oct. 16, 2009, titled “MANAGED CONNECTIVITY IN ELECTRICAL SYSTEMS AND METHODS THEREOF” (also referred to here as the “'395 application”); U.S. Provisional Patent Application Ser. No. 61/253,208, filed on Oct. 20, 2009, titled “ELECTRICAL PLUG FOR MANAGED CONNECTIVITY SYSTEMS” (also referred to here as the “'208 application”); U.S. Provisional Patent Application Ser. No. 61/252,964, filed on Oct. 19, 2009, titled “ELECTRICAL PLUG FOR MANAGED CONNECTIVITY SYSTEMS” (also referred to here as the “'964 application”); U.S. Provisional Patent Application Ser. No. 61/252,386, filed on Oct. 16, 2009, titled “MANAGED CONNECTIVITY IN FIBER OPTIC SYSTEMS AND METHODS THEREOF” (also referred to here as the “'386 application”); U.S. Provisional Patent Application Ser. No. 61/303,961, filed on Feb. 12, 2010, titled “FIBER PLUGS AND ADAPTERS FOR MANAGED CONNECTIVITY” (the “'961 application”); and U.S. Provisional Patent Application Ser. No. 61/303,948, filed on Feb. 12, 2010, titled “BLADED COMMUNICATIONS SYSTEM” (the “'948 application”); and U.S. patent application Ser. No. 13/939,830, filed Jul. 11, 2013, and titled “RFID-Enabled Optical Adapter for Use with a Patch Panel (“the '830 application”).”

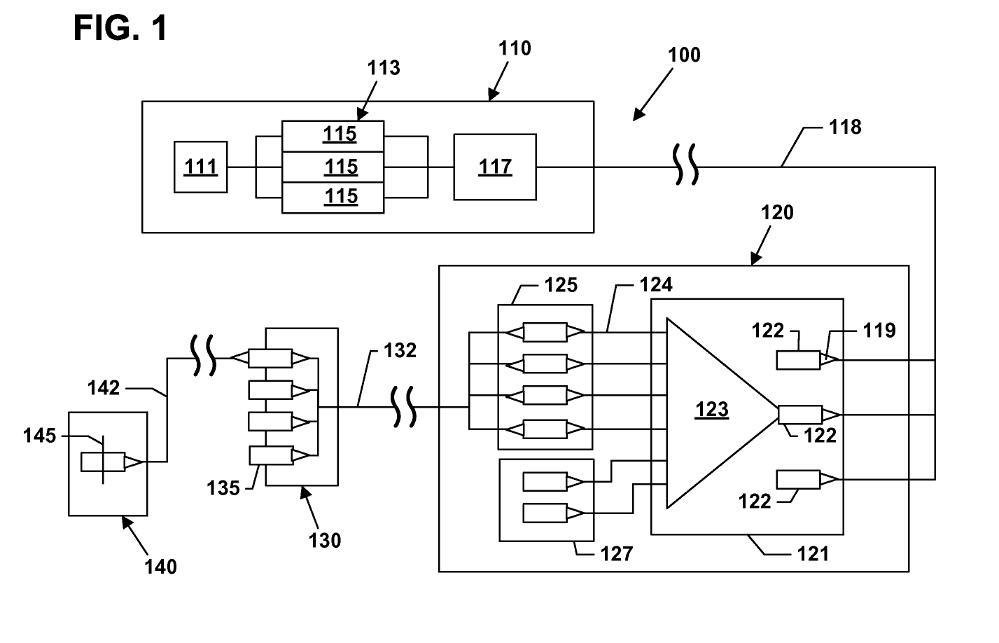

FIG. 1 illustrates one example passive optical network 100 in which PLM management elements can be retrofit. The network 100 includes a central office 110, one or more FDHs 120, one or more MSTs 130, and one or more ONTs 140. Other optical networks can have other configurations and/or other components. The central office 110 includes one or more signal sources 111 from which optical signals are routed to distribution equipment 113 (e.g., at an optical distribution frame) and to a wave division multiplexer (WDM) 117, power splitter, or other such signal router.

A feeder cable 118 is routed from the central office 110 to the FDH 120. In the example shown, a connectorized end 119 of the feeder cable 118 is plugged into an adapter 122 disposed at a splitter location (e.g., a splitter chassis, a splitter shelf, a splitter tray, a splitter drawer, etc.) 121. One or more splitter modules 123 can be mounted at the splitter location. In some implementations, the splitter module 123 can include an optical connector plugged into the adapter 122 to interface with the feeder connectorized end 119. In other implementations, the splitter module 123 can include a connectorized stub cable plugged into the adapter 122. In still other implementations, the splitter module 123 can be spliced to a connectorized stub cable plugged into the adapter 122.

The splitter module 123 splits optical signals carried by the feeder cable 118 onto splitter pigtails 124 that extend from the splitter module 123. One or more of the distal ends of the splitter pigtails 124 can be plugged into a termination field 125 at the FDH 120. For example, the termination field 125 can include one or more adapters disposed at one or more panels, circuit boards, or other such surfaces. In certain implementations, one or more of the distal ends of the splitter pigtails 124 can be plugged into temporary connector storage 127 at the FDH 120.

One or more distribution cables 132 can be interfaced with the splitter pigtails 124 (or fibers optically coupled to the splitter pigtails) at the termination field 125. The distribution cable 132 terminates at an MST 130 (also known as a drop terminal). In some implementations, the distribution cable 132 is plugged into an input adapter at the MST 130. In other implementations, the distribution cable 132 extends into the MST 130 to one or more output adapters 135. Proximal ends of one or more drop cables 142 are plugged into drop cable ports at the output adapters 135. Distal ends of the drop cables 142 are plugged into adapters 145 at an ONT 140 located at or near a subscriber (e.g., a subscriber residence, building, office, etc.).

Example optical distribution frames 113 are disclosed in U.S. patent application Ser. No. 13/766,120, filed on Feb. 13, 2013, and titled “Physical Layer Management (PLM) System for Use With an Optical Distribution Frame Having Trays with Selectable Patch Side (the “120 application”);” U.S. Provisional Patent Application Ser. No. 61/727,450, filed on Nov. 16, 2012, and titled “Patch Panel With RFID Managed Connectivity that is Suitable for Use in Outside Plant;” U.S. patent application Ser. No. 13/766,137, filed on Feb. 13, 2013, and titled “Physical Layer Management (PLM) System for Use with an Optical Distribution Frame in Which Trays Can Be Selectively Removed and Re-Attached;” and U.S. patent application Ser. No. 13/766,151, filed on Feb. 13, 2013, and titled “Physical Layer Management (PLM) System for Use with an Optical Distribution Frame Using RFID Antennas with Localized Fields,” the disclosures of which are hereby incorporated by reference in their entirety.

Example fiber distribution hubs are disclosed in U.S. Pat. Nos. 7,873,255; 7,720,343; 7,816,602; 7,728,225; and U.S. patent application Ser. No. 12/827,423, the disclosures of which are hereby incorporated by reference in their entireties. Example plug and play splitters are disclosed at U.S. Pat. Nos. 7,376,322; 7,593,614; 7,400,813; 7,376,323; and 7,346,254, which are hereby incorporated by reference in their entireties. Example parking modules are disclosed in U.S. Pat. No. 7,809,233 which is hereby incorporated by reference in its entirety. An example drop terminal is disclosed in U.S. Pat. No. 7,512,304, which is hereby incorporated by reference in its entirety.

Other telecommunications networks can include other types of fiber optic enclosures, splice closure, fiber optic drawers/trays, splice trays, aerial splice enclosures, network interface devices, etc. In some implementations, any of the feeder cables 118, the distribution cables 132, and/or the drop cables 142 can be terminated with ruggedized connectors (e.g., single fiber ruggedized connectors or multi-fiber ruggedized connectors).

An example network interface device is disclosed in U.S. patent application Ser. No. 11/607,676 which is hereby incorporated by reference in its entirety. An example splice tray is disclosed at U.S. application Ser. No. 12/425,241 which is hereby incorporated by reference in its entirety. Example fiber optic drawer/trays are disclosed at U.S. patent application Ser. Nos. 12/840,834 and 61/378,710 which are hereby incorporated by reference in their entireties. Example fiber optic enclosures are disclosed at U.S. Pat. Nos. 7,715,679; 7,756,379; and 7,869,682, which are hereby incorporated by reference in their entireties. An example aerial splice enclosure is disclosed at U.S. patent application Ser. No. 12/350,337 that is hereby incorporated by reference in its entirety. An example splice closure is disclosed in U.S. Provisional Patent Application Ser. No. 61/468,405, which is hereby incorporated by reference in its entirety.

An example single fiber ruggedized connector is disclosed at U.S. patent application Ser. No. 12/203,508 which is hereby incorporated by reference in its entirety. An example ruggedized multi-fiber connector is disclosed at U.S. Pat. No. 7,264,402, which is hereby incorporated by reference in its entirety.

In accordance with the principles of the present disclosure, management elements can be incorporated into the various components of the systems disclosed in the above-identified patents and patent applications to store PLI for the components. For example, the management elements can be added to components within a central office, at a fiber distribution hub (FDH), at a multi-service terminal (MST), at an optical network terminal (ONT), and/or at any other location in the network.

In accordance with some aspects of the disclosure, management elements can include RFID circuitry (e.g., RFID tags). The RFID circuitry includes a memory in which PLI is stored, an antenna to broadcast the PLI, and a processor to control the memory and antenna. In certain implementations, the RFID circuitry can include a readable/writable memory. In some implementations, the RFID circuitry can include passive RFID tags that are fully powered by readers. In other implementations, the RFID circuitry can include active RFID tags that include internal batteries to power their processing and broadcasting. In other implementations, the RFID circuitry can include semi passive RFID tags that include internal batteries to power their processing, but rely on a reader to supply power for broadcasting. In still other implementations, the RFID circuitry can be hardwired into a printed circuit board.

In accordance with some aspects of the disclosure, management elements can include graphic codes (e.g., a barcode, a QR code, etc.). The graphic codes include printed indicia indicating PLI or a location (e.g., a URL) at which the PLI is stored.

The PLI stored by the management elements can include various embedded information, such as a photo of the component, an installation manual, information regarding component accessories, reorder information, warranty information, a specific identifying number for identifying the particular component, or other information. In some implementations, the PLI can be stored on (e.g., written to, printed on, etc.) the management elements prior to deployment of the management elements. In other implementations, however, the PLI can be stored on the management elements after the management elements is mounted or otherwise coupled to the component.

The management elements can be installed on telecommunications components after the components have been deployed in the network. For example, the management elements can be installed on connectorized optical cables while connectorized ends of the optical cables are disposed at adapters or other receptacles. The connectorized ends of the cables need not be removed from the adapters prior to installing the management elements. In some implementations, the management elements can be applied to the cables and/or to the respective connectors using adhesive. In other implementations, the management elements can be mechanically applied to the cables and/or to the respective connectors using clips (e.g., snap-on clips), cable ties, crimp sleeves, heat shrink tubing, or other mechanical fasteners. The management elements can be installed on adapters or other equipment components using adhesive, mechanical means, and/or via a printed circuit board that can be fastened or otherwise mounted to the equipment. Various examples of installing management elements on telecommunications components are discussed below.

As disclosed in the '120 application incorporated by reference above, an ODF 113 at the central office 110 can include one or more trays at which optical connections are made via adapters. In some such implementations, PLM can be added to an unmanaged tray by adding management elements (e.g., RFID tags, graphic codes, etc.) to the adapters and/or to the connectors plugged into the adapters without disconnecting the connectors from the adapters. For example, a management element can be affixed to the adapters adjacent the ports using adhesive. Alternatively, the management elements can be affixed to the adapters adjacent the ports using cable ties, fasteners, or other mechanical structures.

In other such implementations, PLM can be added to an unmanaged tray by detaching (unsnapping, unlatching, or otherwise removing) the loaded adapters from the unmanaged tray and attaching the loaded adapters to a managed tray. Certain implementations of a managed tray include a printed circuit board containing RFID circuitry. The loaded adapters would be attached to the printed circuit board so that individual RFID circuits aligned with ports of the adapters (and thereby with any connectors plugged into the ports).

In some implementations, the management elements could be preprogrammed/pre-associated with PLI for the existing ports/connections. In other implementations, however, the PLI information regarding the adapter ports and/or the connectors and/or the cables can be added to a PLM network as described above. In certain implementations, PLI about the adapter ports, cables, and/or connectors can be manually entered by a technician into a software program that connects to the PLM network to upload the information. In an example, a technician may associate (e.g., using a computer program and/or a scanner) PLI with a particular graphic code. In another example, an RFID reader (such as the reader described in the '830 application incorporated by reference above) can be used to write PLI information to RFID circuitry after the loaded adapters are installed on the tray.

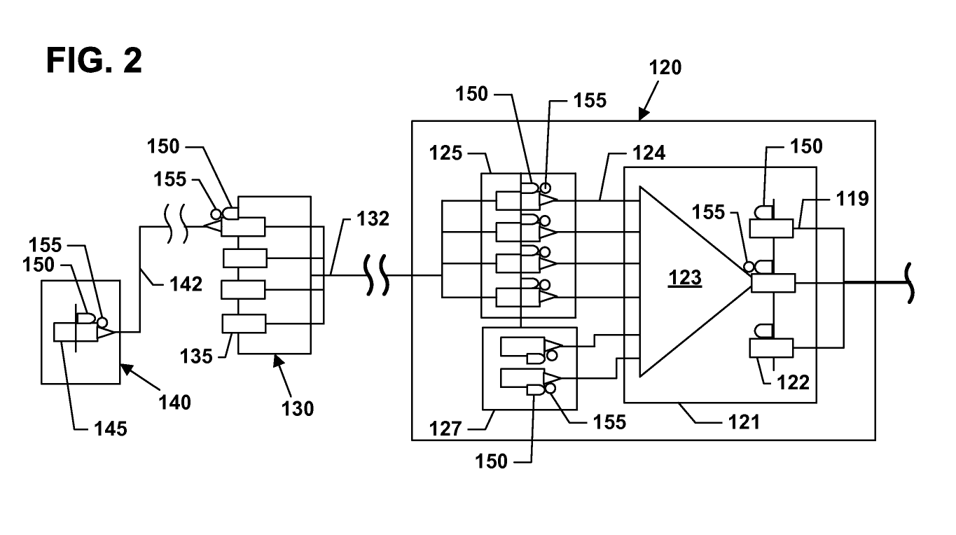

FIG. 2 illustrates one example segment of a field portion of a telecommunications network. The specific example segment shown in FIG. 2 includes an FDH 120 having a splitter location 121, a termination field 125, and/or a connector storage area 127. As shown, management elements can be added to the FDH 120 at one or more of these locations. In some implementations, adapter port RFID tags 150 and connector RFID tags 155 can be added throughout the FDH 120. In other implementations, graphic codes can be added throughout the FDH 120.

In an example implementation, an adapter port tag 150 can be added (i.e., field installed) to each adapter 122 at the splitter location (e.g., at the feeder port, adjacent a release tab of a splitter module 123 plugged into the adapter 122, etc.). An association can be made in the PLM network between the adapter 122 (e.g., the feeder port) and a respective port on the ODF 113 at the central office 110. For example, the association can be manually entered by a technician.

A connector tag 155 can be added (i.e., field installed) to the splitter module 123 (e.g., to an optical connector, to a location adjacent the release tab of the module 123). In certain implementations, the connector tag 155 can be mounted on the splitter module 123 so that the connector tag 155 would be sufficiently close to the adapter port tag 150 of the respective adapter 122 that one reader could read PLI from both tags 150, 155 from the same location (i.e., a single-tap reading). Reading the connector tag 155 allows the splitter module 123 to be automatically associated with the feeder port tag 150.

A connector tag 155 can be added (i.e., field installed) to each splitter pigtail 124 (e.g., to the cable jackets, to the connectors, to the boots, etc.). In various implementations, the connector tag 155 can be glued, crimped, clipped, tied, wrapped, or otherwise attached to the optical connector termination the pigtail 124. In certain implementations, the connector tag 155 can be disposed so as to be oriented vertically when the splitter pigtail is connected to the termination field 125 and/or to the connector storage area 127. The vertical orientation would allow for easy access with a pen reader or other RFID reader.

Adapter port tags 150 can be added (i.e., field installed) at the termination field 125 (e.g., on adapters, on a panel adjacent holding the adapters, on a circuit board holding the adapters, etc.). The adapter port tags 150 are associated (e.g., at the factory, in the field, etc.) with the respective ports of the termination field 125. In certain implementations, the adapter port tags 150 of the termination field 125 are positioned and/or oriented so that the adapter port tags 150 are in sufficiently close proximity to the connector tags 155 of the splitter pigtails 124 that both tags 150, 155 can be read from the same location with an RFID reader. Reading the tags 150, 155 would automatically associate a splitter pigtail 124 (i.e., a splitter output port) with a distribution fiber 132 (i.e., the distribution fiber 132 plugged into an opposite port of the adapter at the termination field 125).

Similarly, adapter port tags 150 can be added (i.e., field installed) to the connector storage area 127 (e.g., on connector holders, on a panel adjacent holding the connector holders, on a circuit board coupled to the connector holders, etc.). In certain implementations, the adapter port tags 150 of the connector storage area 127 are positioned and/or oriented so that the adapter port tags 150 are in sufficiently close proximity to the connector tags 155 of the splitter pigtails 124 that both tags 150, 155 can be read from the same location with an RFID reader. Reading the tags 150, 155 would automatically associate a splitter pigtail 124 (i.e., a splitter output port) with a storage location (e.g., connector holder port).

Distribution fibers 132 extend between the ports of the termination field 125 and the output ports 135 of the MST 130. In some implementations, the termination ports of the termination field 125 can be associated with the output ports of the MST 130 manually (e.g., at the factory, by a technician deploying the MST, etc.). In an example, the association between the termination field ports and the MST output ports does not change after being made.

Adapter port tags 150 can be added (i.e., field installed) to output ports (e.g., drop ports) of the MST 130. Each adapter port tag 150 is associated with a respective MST output port (e.g., at the factory, in the field, etc.). In certain implementations, the adapter port tags 150 can be disposed so as to be clearly visible and accessible with an RFID reader (e.g., a pen reader). Accordingly, the adapter port tags 150 of the MST output ports 135 would be automatically associated within the PLM network with the termination field ports.

Connector tags 155 can be added to the MST-interface ends of the drop cables 142 (e.g., to the cable jackets, to the connectors, to the boots, etc.). In an example, the connector tag 155 can be manufactured as a strip that can be wrapped around an exterior of the MST-interface end. Accordingly, the connector tag 155 can be read from different locations around the MST-interface end, which aids in reading the connector tag 155 after threading the MST-interface end into the drop port. In another example, the connector tag 155 can be coupled to a boot of the MST-interface end (e.g., using heat-shrink tubing). In another example, the connector tag 155 can be crimped to the MST-interface end. In certain implementations, the connector tags 155 can be disposed so as to be clearly visible and accessible with an RFID reader (e.g., a pen reader) when the MST-interface ends are plugged into the MST output ports 135. When a drop cable 142 is installed at one of the MST output ports 135, the connector tag 155 of the MST-interface end can be read with the adapter port tag 150 of the MST output port to link the drop cable 142 to the MST output port and, thereby, to the termination field port and feeder cable.

Connector tags 155 also can be added to the ONT-interface ends of the drop cables 142 (e.g., to the cable jackets, to the connectors, to the boots, etc.). Adapter port tags 150 can be added to the ONT 140 (e.g., to adapters at the ONT 140, to a bulkhead holding the adapters, to a circuit board holding or disposed about the adapters, etc.). These connector tags 155 and adapter ports tags 150 can be disposed and oriented so that the tags 150, 155 can be read with an RFID reader from the same location (i.e., a single-tap read). In certain implementations, the adapter port tags 150 at the ONT 140 can be associated within the PLM network with customer location details.

When all of the tags 150, 155 within the network are scanned, the PLM network will have access to sufficient information to provide visibility of which customers are connected to which ports in the FDH. The PLM network will have access to sufficient information to provide visibility of which FDH ports are available, which FHD ports are connected and not active, and which FDH ports are associated with active customers.

In an alternative implementation, RFID readers can be utilized in place of one or more of the adapter port tags 150. Each RFID reader would be disposed and oriented to be sufficiently close to the connector tag 155 of a respective component and sufficiently far from the connector tags 155 of adjacent components to read only the connector tag 155 of the respective component. For example, an RFID reader disposed at one adapter (or adapter port) at the splitter location 121 of the FDH 120 would be located and oriented so as to read the connector tag 155 of the splitter module 123 plugged into the adapter port and not the connector tags 155 of the splitter modules 123 plugged into adjacent adapter ports. In an example, RFID readers can be utilized in place of the adapter port tags 150 within the FDH 120, but not in place of the adapter port tags 150 on the MST 130 and/or ONT 140.

In accordance with some aspects of the disclosure, management elements can be installed at telecommunications equipment after deployment of the equipment. In fact, management elements can be installed at the equipment after connections have been made at the equipment. Installation of the management elements does not require disconnection of optical connectors or other components from the system. Rather, the management elements can be retro-fit into existing active (i.e., service-providing) systems.

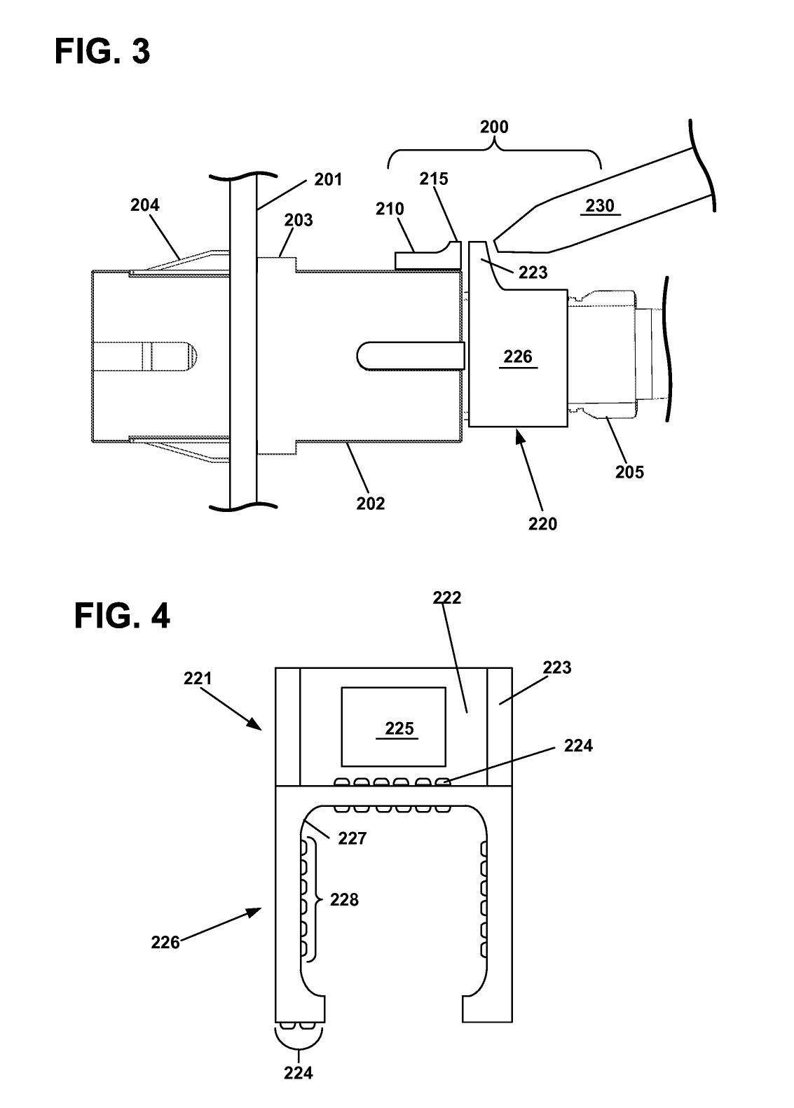

FIGS. 3 and 4 illustrate one example retrofit system 200 for use with one or more optical connectors 205 and one or more optical adapters 202. In the example shown, the adapter 202 is mounted to a bulkhead 201 using bulkhead flanges 203 and springs 204. In other implementations, the adapter 202 may otherwise be mounted to the bulkhead 201 (e.g., as part of an adapter block). The adapter 202 defines a port at each side of the bulkhead 201. The adapter 202 is configured to retain a connector 205 at each port to align optical fibers of the connectors 205. In the example shown, the adapter 202 is an SC adapter and the connector 205 is an SC connector. In other implementations, however, any desired type of adapter and connector can be utilized.

An adapter port tag 215 is positioned at one of the ports of the adapter 202. In some implementations, the adapter port tag 215 is mounted to the adapter 202 using a tag holder 210. In certain implementations, the tag holder 210 has an adhesive backing with which the tag holder 210 mounts to the adapter 202. In other implementations, the tag holder 210 may mechanically mount to the adapter 202 (e.g., using latches, etc.). In certain implementations, the tag holder 210 orients the adapter port tag 215 to facilitate reading of the adapter port tag 215 (e.g., by a pen reader 230). In an example, the tag holder 210 orients the adapter port tag 215 vertically. In an example, the tag holder 210 orients the adapter port tag 215 to be parallel to the bulkhead 201. In an example, the tag holder 210 orients the adapter port tag 215 to be transverse to an insertion axis of the connector 205 into the adapter port.

A connector tag 225 is mounted to the connector 205 using an example connector tag holder 220. The connector tag holder 220 is configured to position the connector tag 225 to facilitate reading of the connector tag 225 (e.g., by the pen reader 230). In certain implementations, the connector tag holder 220 positions the connector tag 225 relative to the adapter port tag 215 so that both tags 215, 225 can be read from the same position (e.g., by the pen reader 230). For example, the connector tag holder 220 positions the connector tag 225 on the connector 205 so that the connector tag 225 is positioned at a port end of the adapter 202 adjacent the adapter port tag 215. In certain implementations, an exterior of the connector tag holder 220 includes a textured surface or other gripping surface 224 to facilitate manipulation of the connector 205 (e.g., removal from or insertion into the adapter 202).

As shown in FIG. 4, the connector tag holder 220 includes a cradle section 221 and a retention section 226. In an example, the cradle section 221 positions the connector tag 225 to be parallel to the adapter port tag 215. In an example, the cradle section 221 positions the connector tag 225 to be vertical. In an example, the cradle section 221 positions the connector tag 225 to be parallel to the bulkhead 201. In the example shown, the cradle section 221 includes a first surface 222 and sidewalls 223. In an example, the sidewalls 223 inhibit reading from adjacent connector tags 225 (e.g., by the pen reader 230). In an example, the sidewalls 223 facilitate proper orientation of the pen reader 230.

The retention section 226 is configured to couple the connector tag 225 to the connector 205. In certain implementations, the retention section 226 defines a channel 227 into which the connector 205 can be inserted (e.g., by snapping the retention section 226 over the connector 205). In certain implementations, the retention section 226 is configured to fit around the connector 205 between the connector key and the connector grip tabs. In certain implementations, the retention section 226 is configured so that the connector tag holder 220 can be mounted to a connector 205 while the connector 205 is plugged into a port of the adapter 202. The connector 205 need not be removed from the port to install the connector tag holder 220. In an example, the channel surfaces of the retention section 226 include adhesive to enhance the connection between the holder 220 and the connector 205. In an example, the channel surfaces of the retention section 226 are textured (see texture 228) or contoured to enhance the connection between the holder 220 and the connector 205.

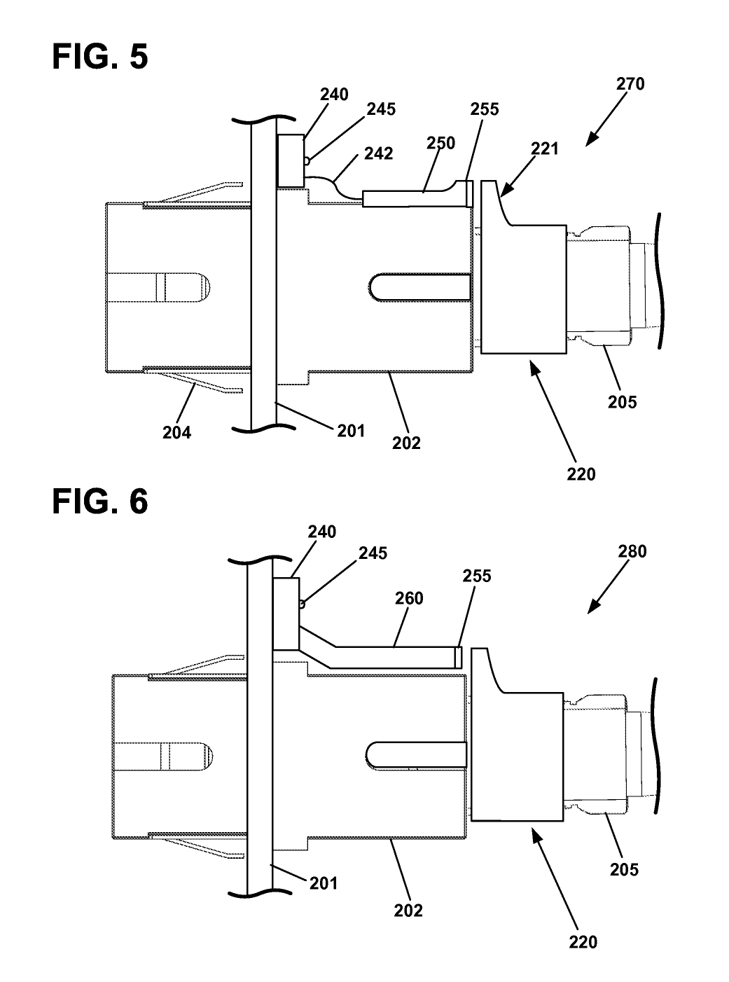

FIGS. 5 and 6 illustrate example retrofit systems 270, 280 for use with one or more optical connectors 205 and one or more optical adapters 202. These retrofit systems 270, 280 utilize an adapter port reader 255 instead of an adapter port tag 215. In the example shown, both of these retrofit systems utilize the connector tag holder 220 and connector tag 225 described above with reference to FIGS. 3 and 4. In other implementations, however, other types of connector tags 225 and connector tag holders 220 can be used with these retrofit systems 270, 280. The reader 255 is configured to read its own stored information and information stored on the connector tags 215 and to communicate this information to the PLM system. In some implementations, power for the readers 255 can be supplied by a power source mounted to the bulkhead 201.

In the retrofit system 270 of FIG. 5, an RFID reader (e.g., a reader coil) 255 is mounted to the adapter 202 at the adapter port using an example reader holder 250. In certain implementations, the reader holder 250 has an adhesive backing with which the reader holder 250 mounts to the adapter 202. In other implementations, the reader holder 250 may mechanically mount to the adapter 202 (e.g., using latches, etc.). In certain implementations, the reader holder 250 is configured so that the reader holder 250 can be mounted to an adapter 202 while the adapter 202 is installed at the bulkhead. In certain implementations, the reader holder 250 orients the RFID reader 255 to facilitate reading of the reader 255 (e.g., by a pen reader 230). In an example, the reader holder 250 orients the reader 255 vertically. In an example, the reader holder 250 orients the reader 255 to be parallel to the bulkhead 201. In an example, the reader holder 250 orients the reader 255 to be transverse to an insertion axis of the connector 205 into the adapter port.

A printed circuit board 240 is mounted to the bulkhead 201 (or elsewhere in a cabinet, frame, rack, drawer, shelf, or other surrounding structure). The reader 255 is coupled to the printed circuit board 240 using a cable 242 or other such connecting member. The printed circuit board 240 includes at least one light source (e.g., an LED) to indicate status of the reader 255 of other information. In some implementations, the printed circuit board 240 is coupled to a controller mounted to the bulkhead 201. The controller operates the reader 255 and/or the light source 245. In certain implementations, the printed circuit board 240 extends across multiple adapters 202 and connectors 205 that have their own retrofit system. In such systems, the controller can operate the readers 255 and/or light sources 245 of the other retrofit systems.

The printed circuit board 240 mounts to the bulkhead 201 external of, but adjacent to the adapter 202. Accordingly, the printed circuit board 240 can be installed at the bulkhead while the adapters 202 are disposed at the bulkhead 201. The adapters 202 need not be removed from the bulkhead 201 to install the printed circuit board 240. In fact, the printed circuit board 240 can be installed at the bulkhead 201 while one or more of the connectors 205 are disposed at the adapter ports. The connectors 205 need not be removed from the adapters 202 to install the printed circuit board 240.

The retrofit system 280 of FIG. 6 is similar to the retrofit system 270 of FIG. 5, except that the reader 255 is mounted to the printed circuit board 240 instead of to the adapter 202. As shown in FIG. 6, the reader 255 of the retrofit system 280 is mounted to a flange 260 extending outwardly from the printed circuit board 240. The flange 260 seats on or hovers over the adapter 202. Support for the flange 260 is provided primarily at the printed circuit board 240. The flange 260 extends sufficiently far from the printed circuit board 240 so to position the reader 255 at the connector tag 215 when the connector 205 is received at the adapter 202. As with the retrofit system 270, the printed circuit board 240 of the retrofit system 280 also can be electrically coupled to the controller mounted to the bulkhead 201.

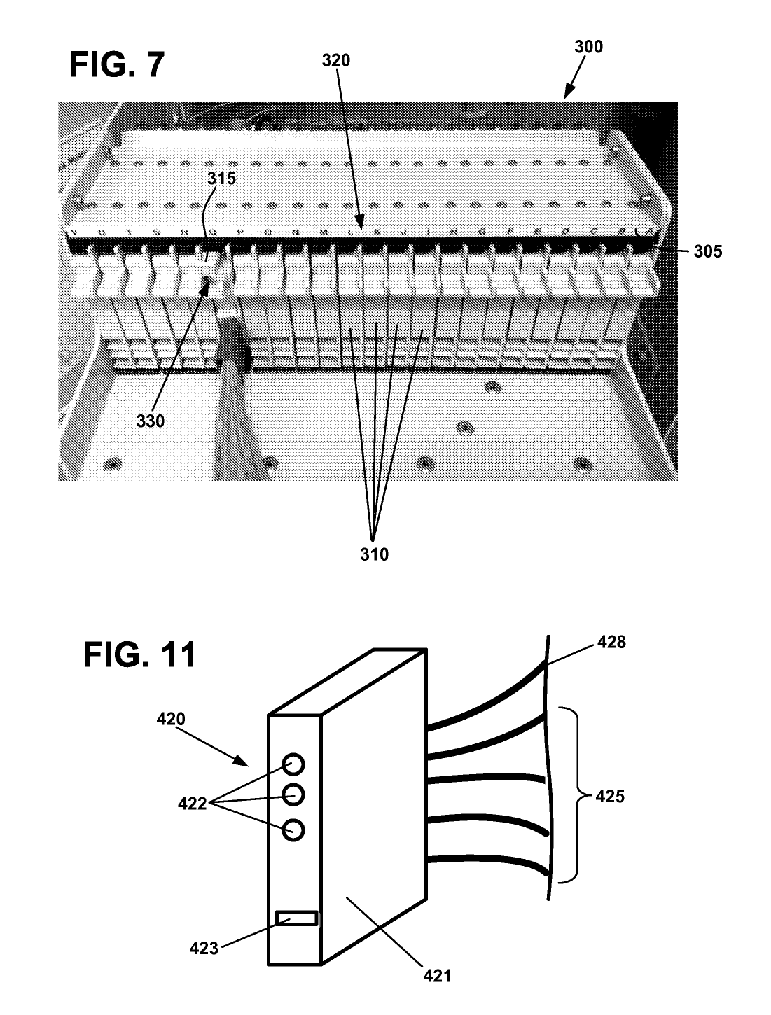

FIG. 7 illustrates one example splitter chassis 300 defining spaces at which one or more splitter modules 310 can be installed. In the example shown, the chassis 300 has twenty-two spaces, only one of which is occupied by a splitter module 310. A different feeder fiber can be routed to each space. A feeder fiber is coupled to a splitter module 310 when the splitter module 310 is installed at the chassis space. Each splitter module 310 is configured to split optical signals from the respective feeder fiber onto multiple splitter pigtails. In certain implementations, the chassis 300 includes a label surface 305 that can identify a splitter module space and/or corresponding feeder fiber. The chassis 300 can be mounted within a cabinet (e.g., a fiber distribution hub), a rack, or other such telecommunications equipment.

Management elements can be added to the splitter chassis 300 and/or splitter modules 310 to add PLM. In some implementations, feeder elements (e.g., RFID tags, RFID readers, graphic codes, etc.) can be attached to the splitter chassis 300 (e.g., to the label surface 305) to associate the feeder elements with the feeder fibers. Splitter elements (e.g., RFID tags, RFID readers, graphic codes, etc.) can be attached to the individual splitter modules 310 (e.g., at a release handle 315). In an example, a reader-type feeder element can overhang the label surface 305 or other part of the chassis 300 to align the reader with a respective splitter module tag-type element without impacting access to the removal latch 315 of the splitter module 310.

In some implementations, a user can associate a splitter module 310 with a particular feeder fiber by scanning (e.g., using a pen reader) the feeder element, scanning the splitter element, and associating the scanned data together. In other implementations, a reader-type element (e.g., the feeder element) can read its own information and information from a respective tag-type element (e.g., the splitter element) and can communicate this information to the PLM system.

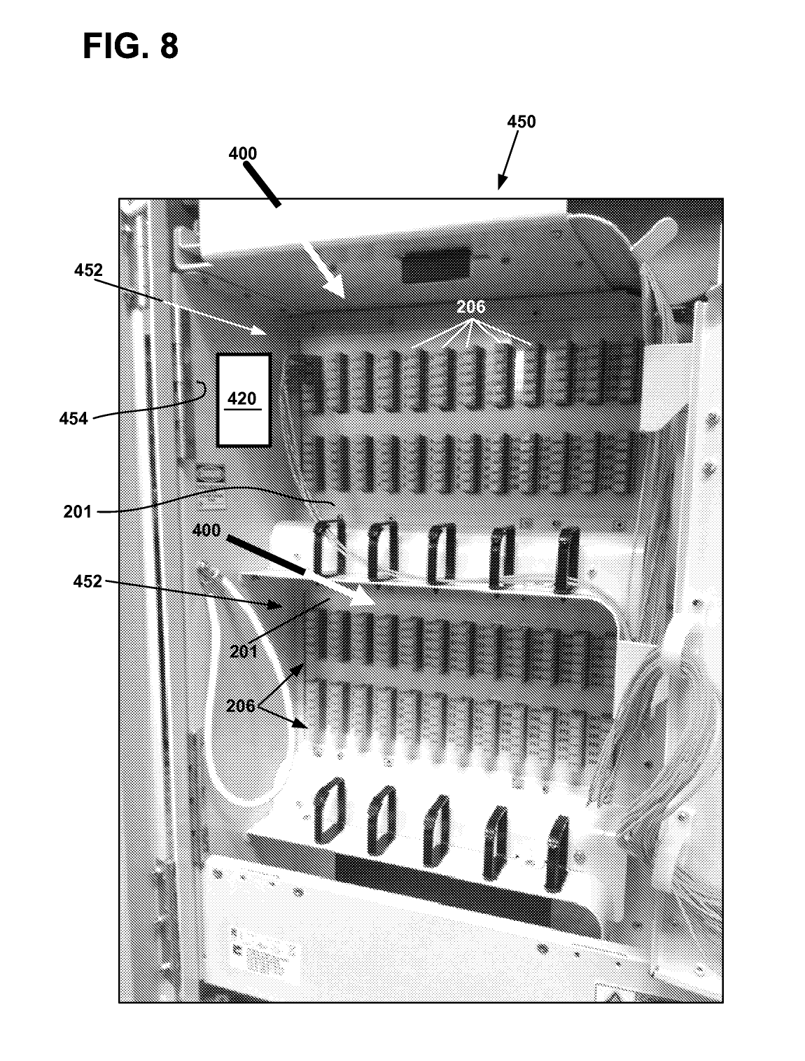

FIGS. 8-11 illustrate a management element holder 400 for termination fields 452 of a cabinet 450 (e.g., a fiber distribution hub), rack, drawer, shelf, or other telecommunications equipment. The termination fields 452 include one or more adapters 202. In certain implementations, the adapter 202 can be arranged in groups 206 of two or more adapters. In the example shown in FIG. 8, the adapters 202 are arranged into groups 206 of six adapters 202. In other implementations, however, the adapter groups 206 can include four, eight, twelve, sixteen, thirty-two, or any other number of adapters 202.

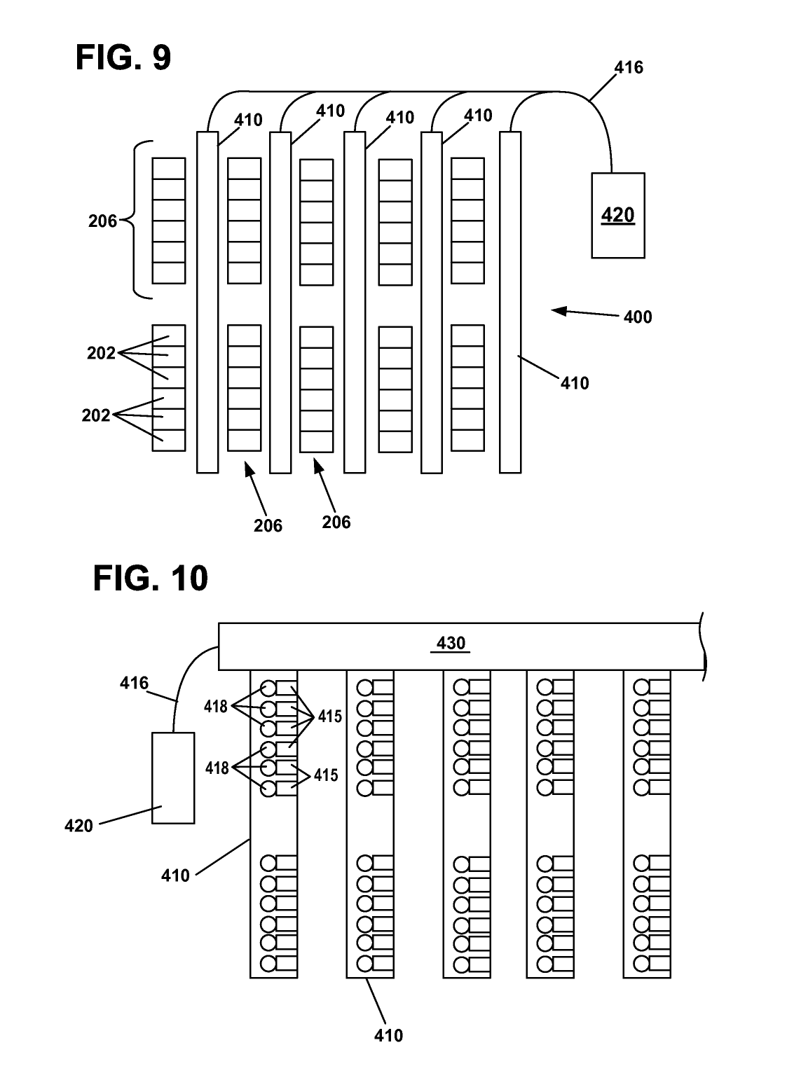

As shown in FIG. 9, an example management element holder 400 can include one or more strips 410 that extend in between groups 206 of adapters 202. Management elements (e.g., RFID readers) can be disposed on the strips 410 so that each management element aligns with one of the adapter 202. One strip 410 can provide management elements for one or more groups 206 of adapters 202. Accordingly, the strips 410 would facilitate installation of the management elements at the termination field 252. In some implementations, the strips 410 can be attached using adhesive. In other implementations, the strips 410 can be attached using other mechanical measures (e.g., latching, fasteners, etc.). The strips 410 are electrically connected (see 416) to a controller 420, an example of which will be described in more detail herein.

FIG. 10 illustrates one example implementation of the management element holder 400. The management element holder 400 includes multiple strips 410 coupled to a connecting circuit board 430. Each of the strips 410 also includes a circuit board coupled to (or integral with) the connecting circuit board 430. The connecting board 430 functions as a bus, connecting the components on each strip 410 to a controller 420. In the example shown, the strips 410 are dimensioned to fit between columns of the adapters 202. In other implementations, the strips 410 can be dimensioned to fit between rows, or other groups of adapters. The shape and dimensions of the holder 400 enable the holder 400 to be installed at the termination field 452 after installation of the adapters 202. In fact, the holder 400 can be installed after installation of one or more connectors 205 at the adapters 202.

In the example shown, each strip 410 includes one or more RFID readers 415 (e.g., adapter port reader 255 of FIGS. 5 and 6) that align with adapter ports when the management element holder 400 is installed at a termination field 452. In other implementations, other types of management elements can be mounted to the strips 410 instead of the readers 415.

In some implementations, the management elements 415 of each strip 410 can be preprogrammed (e.g., in the factory) to associate the management element 415 with a port identification or any other PLI relating to the termination field 452. Accordingly, a technician can provide PLM to the termination field 452 by installing the management element holder 400 at the field 452 without the need to scan each management element.

In certain implementations, each strip 410 also includes one or more light sources (e.g., LEDs) 418 for each adapter port. The light source 418 can provide an indication of a particular port. For example, the light source 418 can be activated to identify the respective port to alert a technician for servicing. The light source 418 also can be activated to indicate a status of the port (e.g., connected, available, improper connection, etc.). The light source 418 can be configured to shine in different colors or to have different blink speeds. In certain implementations, each strip 410 can include printed port indicia (e.g., alphanumeric characters) identifying the port to a technician.

In alternative implementations, another example management element holder could attach management elements to the adapters 202 at the termination field 252. For example, each management element holder could be configured to attach to one group 206 of adapters 202. The management element holder could be preprogrammed (e.g., in the factory) to associate the management element 415 with a port identification or any other PLI relating to the adapters 202 of the group 206. Accordingly, a technician can provide PLM to the termination field 452 by installing the management element holders at the field 452 without the need to scan each management element.

The management element holder 400 is coupled to a controller 420 (e.g., using a cable, using a connecting board, etc.) mounted (e.g., via a bracket) within the cabinet or other equipment. The controller 420 operates the readers 415 and/or the light sources 418 on the strips 410. FIG. 11 also shows one example controller 420 including connections (e.g., cable connections) 425 to the management elements at the termination field (e.g., via the management elements holders 400). The controller 420 also can be configured to connect to management elements at a splitter chassis (e.g., splitter chassis 300 of FIG. 7).

Certain types of controllers 420 also can include an interface port 423 at which a portable scanner and/or a power source can be connected to the controller 420. Certain types of controllers 420 also can include one or more light sources (e.g., LEDs) or other indicators 422. The light sources 422 can be configured to provide light of one or more colors. The light sources 422 can be configured to provide various light patterns (e.g., slow blink, fast blink, etc.). In an example, the light sources 422 can be used to indicate a status of the management elements.

As shown in FIG. 8, the controller 420 can be mounted adjacent the termination field 452. In the example shown, a low-profile example of the controller 420 is mounted to a sidewall 454 adjacent one of the termination fields 452. FIG. 11 also shows one example low-profile controller 420. The controller 420 is low-profile when the dimension extending into the cabinet (the width in FIG. 8) is smaller than the other dimensions. In an example, the controller 420 is low-profile when the dimension extending into the cabinet (the width in FIG. 8) is significantly smaller (i.e., less than half) the other dimensions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method of retrofitting telecommunications equipment to work with a management system, the telecommunications equipment including a plurality of optical adapters loaded with optical connectors, the method comprising:
(a) installing a plurality of connector tags on the optical connectors while the optical connectors are retained at the optical adapters, the connector tags including electronic memory and being configured for RF communication;
(b) installing a plurality of adapter port elements at the optical adapters while the optical connectors are retained at the optical adapters;
(c) reading information stored on the connector tags and providing the read information to the management system.

2. The method of claim 1, wherein the adapter port elements include RFID tags.

3. The method of claim 1, wherein the adapter port elements include RFID readers.

4. The method of claim 1, wherein installing the adapter port elements comprises:
attaching a circuit board to a panel at which a first of the optical adapters is supported;
attaching a flange to the circuit board so that the flange extends over a portion of the first optical adapter;
attaching one of the adapter port elements to the flange so that the adapter port element is disposed adjacent the first optical adapter without being supported by the first optical adapter.

5. The method of claim 1, wherein installing the adapter port elements comprises:
providing the adapter port elements on strips of a single-piece circuit board arrangement; and
positioning the circuit board arrangement so that the strips extend between groups of optical adapters and so that each adapter port element aligns with a port of one of the optical adapters.

6. The method of claim 1, further comprising installing a low-profile system controller adjacent the termination field; and coupling the low-profile system controller to the adapter port elements of the circuit board arrangement.

7. A fiber distribution network comprising:
a cabinet including:
a splitter region defining a plurality of slots at which splitter modules can be received, each slot being configured to optically couple to a feeder fiber;
a plurality of feeder port elements disposed at the splitter region, each feeder port element being associated with one of the slots; and
at least one splitter module configured to be received at one of the slots of the splitter region, the splitter module including an RFID tag, the splitter module including a feeder connector and a plurality of splitter pigtails.

8. The fiber distribution network of claim 7, wherein the feeder port elements include RFID tags.

9. The fiber distribution network of claim 7, further comprising a termination region including a plurality of optical adapters having first ports and second ports, the second ports retaining distribution fibers, and at least one of the first ports receiving a splitter pigtail, wherein the splitter pigtail includes a connector RFID tag mounted to the splitter pigtail external of the respective optical adapter; and wherein an adapter port element is positioned adjacent the connector RFID tag.

10. The fiber distribution network of claim 9, wherein the adapter port element includes an adapter port reader.

11. The fiber distribution network of claim 9, wherein the adapter port element includes an adapter port RFID tag.

12. The fiber distribution network of claim 7, wherein the cabinet is a fiber distribution hub including a termination region; and wherein the fiber distribution network further comprises:
at least a first splitter module disposed at the splitter region, the first splitter module including a feeder connector and a plurality of splitter pigtails;
at least one multi-service terminal including a plurality of drop ports;
at least one optical network terminal including at least one optical adapter;
at least a first drop cable having a first end coupled to a first of the drop ports and a second end coupled to the optical adapter at the optical network terminal; and
a plurality of connector RFID tags including a first of the connector tags being disposed on one of the splitter pigtails; a second connector tag being disposed at the first end of the first drop cable; and a third connector tag being disposed at the second end of the first drop cable, each of the connector tags being configured to be installed while the splitter pigtail and first drop cable are connected within the network.

13. The fiber distribution network of claim 12, further comprising a fourth connector tag disposed at the feeder connector.

14. The fiber distribution network of claim 12, wherein each of the connector RFID tags is configured to be attached to an optical fiber cable using one of the following: snap-fit connection, crimp, heat shrink materials, cable tie, and adhesive.

15. The fiber distribution network of claim 12, further comprising a plurality of adapter port elements including a first adapter port element disposed at the termination region, a second adapter port element disposed at the first drop port, and a third adapter port element disposed at the optical adapter of the optical network terminal.

16. A circuit board arrangement comprising:
a first circuit board section;
a plurality of circuit board strips extending from the first circuit board section; and
a plurality of RFID elements disposed on the circuit board strips, the management elements being separated into groups.

17. The circuit board arrangement of claim 16, wherein the RFID elements include RFID tags.

18. The circuit board arrangement of claim 16, wherein the RFID elements include RFID readers.

19. The circuit board arrangement of claim 16, further comprising a plurality of light indicators, each light indicator being associated with one of the RFID elements.

20. The circuit board arrangement of claim 16, further comprising a system controller coupled to the first circuit board section.
